(19) United States
(12) Patent Application Publication
(10) Pub. No.: US 2023/0206817 A1
(43) Pub. Date: Jun. 29, 2023

(54) DISPLAY PANEL AND BRIGHTNESS RESTORATION METHOD THEREOF, DISPLAY MODULE AND STORAGE MEDIUM

(71) Applicants: Changsha HKC Optoelectronics Co., Ltd., Changsha City (CN); HKC CORPORATION LIMITED, Shenzhen (CN)

(72) Inventors: Kerong WU, Changsha City (CN); Rongrong LI, Changsha City (CN)

(73) Assignees: Changsha HKC Optoelectronics Co., Ltd., Changsha City (CN); HKC CORPORATION LIMITED, Shenzhen (CN)

(21) Appl. No.: 18/091,195

(22) Filed: Dec. 29, 2022

(30) Foreign Application Priority Data
Dec. 29, 2021 (CN) 202111643377.5

(51) Int. Cl. G09G 3/20; G09G 3/3208

(52) U.S. Cl. CPC G09G 3/2074; G09G 3/3208; G09G 2300/0408; G09G 2300/0452; G09G 2320/0626; G09G 2360/14

(57) ABSTRACT

Disclosed are a display panel and brightness restoration method, display module and storage medium. The method includes: detecting a brightness of each sub-pixel in the display panel 100, the display panel includes a number of sub-pixels arranged in a preset arrangement manner, the number of sub-pixels include sub-pixels of different colors, the preset arrangement manner is that the sub-pixels of each color is adjacent to at least one of the sub-pixels of the same color; restoring the brightness of the display panel based on at least one second target sub-pixel that is adjacent to the first target sub-pixel and has an identical color to that of the first target sub-pixel pixels, if a first target sub-pixel with abnormal brightness in the display panel is detected. Problem that the brightness restoration method of the display panel damages the display area around the defect points is solved through the present disclosure, and the beneficial effect of efficient repair of the light and dark spots in the display panel is realized.

### CROSS-REFERENCE TO RELATED APPLICATIONS

This present application claims priority under 35 U.S.C. § 119 to Chinese patent application No. 202111643377.5, filed on Dec. 29, 2021 before the China National Intellectual Property Administration of the People’s Republic of China, the contents of which is explicitly incorporated herein by reference in its entirety.

### FIELD

The present disclosure relates to the field of display technology, and in particular, to a display panel and a brightness restoration method thereof, a display module and a storage medium.

### BACKGROUND

Organic Light Emitting Diode (OLED) display screens are thin and light, with high brightness, low power consumption, fast response, high definition, good flexibility, and high luminous efficiency, which can meet the new demands of consumers for display technology. More and more display screens manufacturers around the world have invested in research and development, which has greatly promoted the industrialization process of OLED.

The brightness restoration method of the display panel in the existing art is using laser to remove impurities in the short-circuit area, but this method will damage the display area around the defect point.

### SUMMARY

In a aspect, a display panel is provided, comprising a substrate, and a plurality of pixel units provided on the substrate, each of the pixel units comprises a plurality of sub-pixels arranged in a preset arrangement manner, the preset arrangement manner is that the sub-pixels of each color is adjacent to at least one of the sub-pixels of the same color.

In other aspect, a method for restoring brightness of a display panel is provided, wherein the method comprises: detecting a brightness of each sub-pixel in the display panel; wherein the display panel comprises a plurality of pixel units provided on the substrate, wherein each of the pixel units comprises a plurality of sub-pixels arranged in a preset arrangement manner, and the preset arrangement manner is that each sub-pixel of each color is adjacent to at least one of the sub-pixels of the same color, restoring a brightness of the display panel based on at least one second target sub-pixel that is adjacent to the first target sub-pixel and has an identical color to that of the first target sub-pixel pixels, if a first target sub-pixel with abnormal brightness in the display panel is detected..

In further aspect, a display module is provided, the display module comprised a display panel of the present disclosure and a repair module connected with the display panel, the repair module comprises: a detection sub-module, configured to detect a brightness of each sub-pixel in the display panel; the display panel comprises a plurality of pixel units provided on the substrate, wherein each of the pixel units comprises a plurality of sub-pixels arranged in a preset arrangement manner, and the preset arrangement manner is that each sub-pixel of each color is adjacent to at least one of the sub-pixels of the same color; a restoration sub-module, configured to restore a brightness of the display panel based on at least one second target sub-pixel that is adjacent to the first target sub-pixel and has an identical color to that of the first target sub-pixel pixels if a first target sub-pixel with abnormal brightness in the display panel is detected.

In yet other aspect, a computer-readable storage medium on which a computer program is stored is provided, wherein, the method for restoring brightness of a display panel is implemented when the program is executed by a processor.

Display panel, brightness restoration method of the display panel and display module are provided by the embodiments of present disclosure, wherein the display panel comprising a substrate, and a plurality of pixel units provided on the substrate, each of the pixel units comprises a plurality of sub-pixels arranged in a preset arrangement manner, the preset arrangement manner is that the sub-pixels of each color is adjacent to at least one of the sub-pixels of the same color; since the sub-pixels of each color is adjacent to at least one of the sub-pixels of the same color in the display panel, therefore, when a dark spot defect or a bright spot defect occurs on the display panel, according to the first target sub-pixel with the dark spot defect or bright spot defect and the second target sub-pixel of the same color adjacent to the first target sub-pixel, compensating and restoring the brightness of the display panel by means of mutual compensation of brightness of sub-pixels of adjacent colors. When the display panel designed in this way has defects, it is not necessary to repair the bright and dark spots by laser cutting, thereby preventing damage to adjacent pixels and realizing efficient repair to bright and dark spots in the display panel, thereby improving the display effect of the display panel.

Based on this, in the case that the first target sub-pixel with abnormal brightness is detected in the display panel, the brightness of at least one second target sub-pixel adjacent to the first target sub-pixel with the same color as the first target sub-pixel increases to achieve the effect of restoring the brightness of the display panel, that is, when display panel appears dark spot defect or bright spot defect, brightness of display panel may be restored according to the sub-pixel with dark spot defect or bright spot defect and the sub-pixel with the same color in its adjacent pixel unit.

Compared to related technologies, display panel, brightness restoration method of the display panel and display module are provided by the embodiments of present disclosure, wherein the display panel comprising a substrate, and a plurality of pixel units provided on the substrate, each of the pixel units comprises a plurality of sub-pixels arranged in a preset arrangement manner, the preset arrangement manner is that the sub-pixels of each color is adjacent to at least one of the sub-pixels of the same color; since the sub-pixels of each color is adjacent to at least one of the sub-pixels of the same color in the display panel, therefore, when a dark spot defect or a bright spot defect occurs on the display panel, according to the first target sub-pixel with the dark spot defect or bright spot defect and the second target sub-pixel of the same color adjacent to the first target sub-pixel, dark spot defects are compensated by improving the brightness of sub-pixels of adjacent colors, bright spots are turned into dark spots by cutting off the power supply circuit of bright spot defects, and dark spot defects are compensated by improving the brightness of sub-pixels of adjacent colors, so as to restore the brightness of the display panel. When the display panel designed in this way has defects, it is not necessary to repair the bright and dark spots by laser cutting, thereby preventing damage to adjacent pixels and realizing efficient repair to bright and dark spots in the display panel, thereby improving the display effect of the display panel.

Details of one or more embodiments of the present disclosure are given in the attached drawings and descriptions below to make the other characteristics, purposes and advantages of this application more concise and understandable.

### BRIEF DESCRIPTION OF THE DRAWINGS

The drawings herein are incorporated into and form part of the description, which shows embodiments that meet the requirements of the present disclosure and are used in conjunction with the description to explain the rationale of the present disclosure.

In order to more clearly illustrate the embodiments of the present disclosure, the following briefly introduces the accompanying drawings that are required to be used in the description of the embodiments.

FIG. 1 is a schematic diagram of the arrangement of RGB pixels in a display panel according to an embodiment of the present disclosure;

FIG. 2 is a schematic diagram of an arrangement of RGBW pixels in a display panel according to an embodiment of the present disclosure;

FIG. 3 is the first flowcharts of a method for restoring brightness of a display panel according to an embodiment of the present disclosure;

FIG. 4 is the second flowchart of a method for restoring brightness of a display panel according to an embodiment of the present disclosure;

FIG. 5 is the third flowchart of a first embodiment of a method for restoring brightness of a display panel according to an embodiment of the present disclosure;

FIG. 6 is the fourth flowchart of an another embodiment of a method for restoring brightness of a display panel according to an embodiment of the present disclosure;

FIG. 7 is the fifth flowchart of a third embodiment of a method for restoring brightness of a display panel according to an embodiment of the present disclosure;

FIG. 8 is the sixth flowchart of a fourth embodiment of a method for restoring brightness of a display panel according to an embodiment of the present disclosure;

FIG. 9 is the seventh flowchart of a fifth embodiment of a method for restoring brightness of a display panel according to an embodiment of the present disclosure;

FIG. 10 is the eighth flowchart of a sixth embodiment of a method for restoring brightness of a display panel according to an embodiment of the present disclosure;

FIG. 11 is the ninth flowchart of a seventh embodiment of a method for restoring brightness of a display panel according to an embodiment of the present disclosure;

FIG. 12 is the tenth flowchart of an eighth embodiment of a method for restoring brightness of a display panel according to an embodiment of the present disclosure;

FIG. 13 is one of the schematic structural diagrams of the display module in the embodiment of the disclosure;

FIG. 14 is another schematic diagram of the structure of the display module in the embodiment of the disclosure; and

FIG. 15 is a schematic structural diagram of an electronic device in an embodiment of the present disclosure.

### DETAILED DESCRIPTION

In order to make the purposes, technical solutions and advantages of the embodiments of the present disclosure clearer, the technical solutions in the embodiments of the present disclosure will be clearly and completely described below with reference to the drawings in the embodiments of the present disclosure. Obviously, the described embodiment is a part of the embodiments of the present disclosure, but not all of the embodiments. Based on the embodiments in the present disclosure, all other embodiments obtained by those of ordinary skill in the art without creative work shall fall within the protection scope of the present disclosure.

The technical solutions in the embodiments of the present disclosure will be described below with reference to the accompanying drawings in the embodiments of the present disclosure.

An embodiment of the present disclosure provides a display panel, comprising a substrate, and a plurality of pixel units provided on the substrate, wherein each of the pixel units comprises a plurality of sub-pixels arranged in a preset arrangement manner, the preset arrangement manner is that the sub-pixels of each color is adjacent to at least one of the sub-pixels of the same color.

In some embodiments, a pixel unit of display panel provided by the present disclosure comprises N sub-pixels, areas corresponding to pixel units are divided into N rectangular areas, and the N rectangular areas of the pixel unit is filled by the N sub-pixels respectively, and a rectangular area is filled with one sub-pixel; N is a positive integer greater than 2.

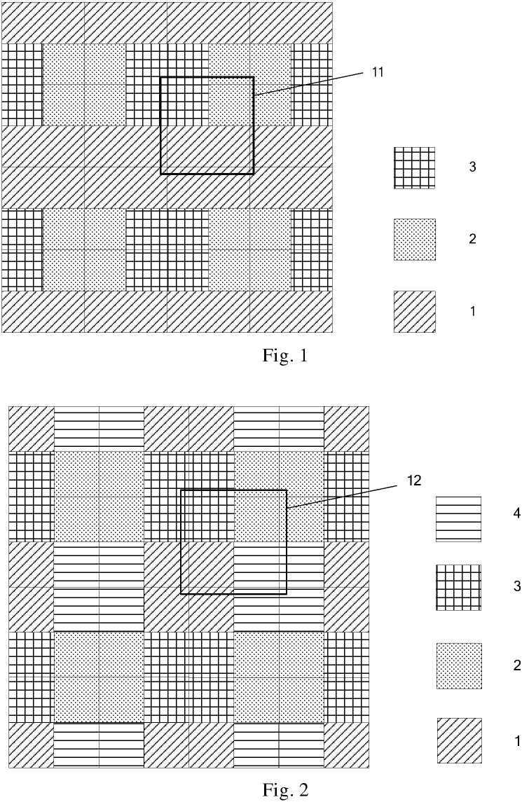

In some embodiments, when the number of sub-pixel is three, as shown in FIG. 1, the pixel unit 11 is divided into three rectangular areas, the three rectangular area of the pixel unit is filled by the three sub-pixels respectively; in another exemplary example, when the number of sub-pixel is 4, as shown in FIG. 2, the pixel unit 12 is divided into four rectangular areas, and the four rectangular area of the pixel unit is filled by the four sub-pixels respectively.

In some embodiments, the sub-pixels in the implementation of the present disclosure may include, but are not limited to, red sub-pixels R, green sub-pixels G, blue sub-pixels B, and white sub-pixels W; each sub-pixel is adjacent to at least one sub-pixel of the same color. A pixel unit is divided into three grids, one end of the pixel unit is one grid, the other end of the pixel unit is two grids, and the area of the pixel unit is fully filled by the three grid area. One sub-pixel is arranged in one grid at one end of the pixel unit, and the other two sub-pixels are arranged in two grids at the other end of the pixel unit. The color of any sub-pixel of the pixel unit and the adjacent sub-pixels of other adjacent pixel units are the same.

In some embodiments, the display panel is an OLED display panel. As shown in FIG. 1, the OLED display panel comprises a red sub-pixel 1, a green sub-pixel 2, and a blue sub-pixel 3, one of the sub-pixels is arranged in one grid at one end of the pixel unit 11, the other two sub-pixels are arranged in two grids at the other end of the pixel unit 11, and the colors of any sub-pixel and the adjacent sub-pixels of other adjacent pixel units 11 are the same. That is, each sub-pixel is adjacent to at least one sub-pixel of the same color. It should be noted that FIG. 1 is only one of the possible positional relationships of the sub-pixels, and the sub-pixels of one grid at one end can be any one of red sub-pixels, green sub-pixels, and blue sub-pixels that are not the same color as other sub-pixels in this pixel unit. Similarly, the sub-pixels of the two grids at the other end may be any one of the red sub-pixels, the green sub-pixels, and the blue sub-pixels that are not of the same color as other sub-pixels in the pixel unit.

In some embodiments, as shown in FIG. 2, the OLED display panel comprises a red sub-pixel 1, a green sub-pixel 2, a blue sub-pixel 3, and a white sub-pixel 4, each sub-pixel is adjacent to at least one sub-pixel of the same color. The pixel unit 12 is divided into a four rectangular area of an upper left, an upper right, a lower left and a lower right, four sub-pixels are respectively located in the four rectangular area of the pixel unit 12, and the color of any sub-pixel of the pixel unit 12 is same as the color of the adjacent sub-pixels in other adjacent pixel unit 12. It should be noted that FIG. 2 is only one of the possible positional relationships of the sub-pixels, and the sub-pixel located in the upper left grid rectangular area can be any one of the red sub-pixel, green sub-pixel, blue sub-pixel and white sub-pixel that is not the same color as other sub-pixels in this pixel unit. Similarly, the sub-pixels in other grids may be any sub-pixels of red sub-pixels, green sub-pixels, blue sub-pixels and white sub-pixels that are not of the same color as other sub-pixels in the pixel unit.

Based on this, a brightness of the display panel is restored based on at least one second target sub-pixel adjacent to the first target sub-pixel and has the same color as the first target sub-pixel pixels, if a first target sub-pixel with abnormal brightness in the display panel is detected. That is, when a dark spot defect or a bright spot defect occurs in the display panel, the brightness of the display panel can be restored according to the sub-pixel with the dark spot defect or the bright spot defect and the same color sub-pixel in its adjacent pixel unit.

In some embodiments, the sub-pixels of each pixel unit in the display panel are arranged in such a way that the sub-pixel of each color is adjacent to at least one of the sub-pixels of the same color, such that the color of the adjacent sub-pixels is the same between the adjacent pixel units, and each pixel unit can be controlled separately. Therefore, when a sub-pixel of any color in a pixel unit has a dark spot or bright spot defect, the sub-pixel of the same color in the adjacent pixel unit can work normally for the pixel unit with a dark spot or bright spot defect. Furthermore, it provides the possibility to separately control the adjacent normal working sub-pixels of the same color, so as to achieve certain compensation for the occurrence of dark spots or bright spot defects of sub-pixels.

In some embodiments, when dark spot defect or bright spot defect occurs due to insufficient brightness of sub-pixel in the display panel, the brightness of the display panel can be restored to a certain extent according to the sub-pixel with dark spot defect or bright spot defect and the sub-pixel of the same color in its adjacent pixel unit.

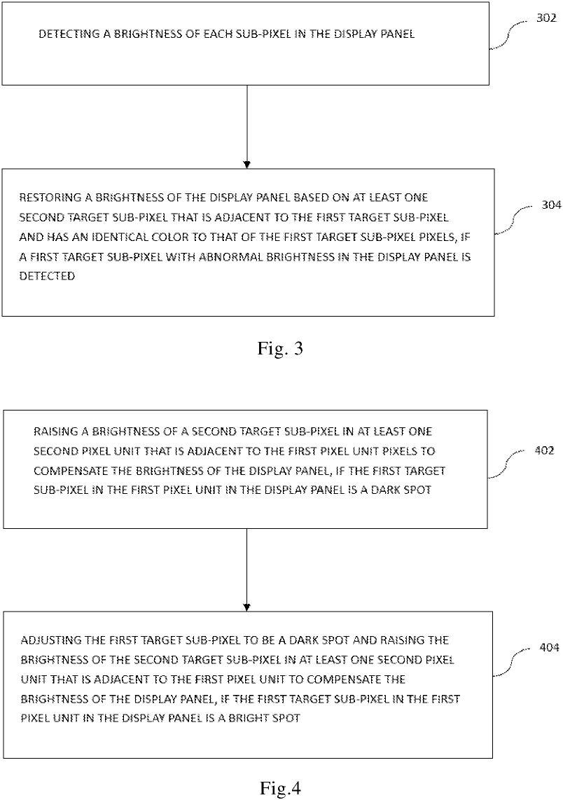

A method for restoring brightness of a display panel is also provided by an embodiment of the present disclosure, the display panel comprises a substrate, and a plurality of pixel units provided on the substrate, wherein each of the pixel units comprises a plurality of sub-pixels arranged in a preset arrangement manner, and the preset arrangement manner is that each sub-pixel of each color is adjacent to at least one of the sub-pixels of the same color, as shown in FIG. 3, the method comprises step 302 and step 304.

At step 302, detecting a brightness of each sub-pixel in the display panel; and

At step 304, restoring a brightness of the display panel based on at least one second target sub-pixel that is adjacent to the first target sub-pixel and has an identical color to that of the first target sub-pixel pixels, if a first target sub-pixel with abnormal brightness in the display panel is detected.

In some embodiments, the display panel comprises a plurality of sub-pixels arranged in a preset arrangement manner, the plurality of sub-pixels comprises a plurality of sub-pixels of different colors, and the preset arrangement manner is that the sub-pixels of each color is adjacent to at least one of the sub-pixels of the same color. There are many ways to detect the brightness value of sub-pixels. For example, the power supply current and voltage corresponding to the pixel unit can be controlled. In addition, image recognition can also be adopted.

In some embodiments, it should be noted that each sub-pixel corresponds to a different color; according to different sub-pixel colors, the sub-pixels include but are not limited to red sub-pixels, green sub-pixels, blue sub-pixels, and white sub-pixels.

In some embodiments, it should be noted that the brightness restoration means to adjust the brightness, abnormal brightness of the sub-pixels comprises the occurrence of dark spot defects in the sub-pixels and the occurrence of bright spot defects in the sub-pixels; restoring the brightness of the display panel involves increasing the brightness value of at least one second object sub-pixel adjacent to the first object sub-pixel and in the same color as the first object sub-pixel.

In the above step 302 to step 304 of the embodiment of the present disclosure, the display panel comprises a substrate, a plurality of pixel units provided on the substrate, each of the pixel units comprises a plurality of sub-pixels arranged in a preset arrangement manner, the preset arrangement manner is that the sub-pixels of each color is adjacent to at least one of the sub-pixels of the same color. By the method for restoring brightness in the embodiment of the present disclosure, the brightness of the display panel based on at least one second target sub-pixel that is adjacent to the first target sub-pixel and has an identical color to that of the first target sub-pixel pixels, if a first target sub-pixel with abnormal brightness in the display panel is detected; that is, according to the first target sub-pixel with the dark spot defect or bright spot defect and the second target sub-pixel of the same color that is adjacent to the first target sub-pixel, the brightness of the display panel can be compensated and restored, it is not necessary to repair the bright and dark spots by laser cutting, thereby preventing damage to adjacent pixels and realizing efficiently repairing to bright and dark spots in the display panel, thereby solving the technical problem that the brightness restoration method of the display panel in the prior art will damage the display area around the defective spot.

In some embodiments, a method for restoring brightness of a display panel provided by the present disclosure comprises N sub-pixels, areas corresponding to pixel units are divided into N rectangular areas, and the N rectangular areas of the pixel unit is filled by the N sub-pixels respectively, and a rectangular area is filled with a sub-pixel; N is a positive integer greater than 2.

In some embodiments, it should be noted that, in an exemplary example of this embodiment, when the pixel unit consists of 4 sub-pixels, the pixel unit is square, and the square pixel unit is divided into four sub-pixels for being filled by 4 sub-pixels respectively.

It can be seen that the pixel unit in the brightness restoration method of the display panel provided by the embodiment of the present disclosure is divided into squares that equal to the number of sub-pixels, and each sub-pixel occupies one grid.

In some embodiments, a method for restoring brightness of a display panel is provided by the present disclosure, wherein the pixel unit comprises a red sub-pixel, a green sub-pixel, and a blue sub-pixel, one of the sub-pixels is provided at one end of the pixel unit, other two sub-pixels are provided at the other end of the pixel unit, and a color of any one sub-pixel of the pixel unit is same as the color of adjacent sub-pixels of other adjacent pixel units.

In some embodiments, it should be noted that, when the number of sub-pixel is three, pixel unit comprises red sub-pixel, green sub-pixel and blue sub-pixel, the pixel unit is square, and dividing the square pixel unit into at least two areas for filling at least two sub-pixels comprises: setting the pixel unit to be a square, and dividing the square pixel unit into 3 grids for filling the first sub-pixel, the second sub-pixel, and the third sub-pixel; specifically, as shown in FIG. 1, one of the sub-pixels is installed on one end of the pixel unit, the other two sub-pixels are installed on the other end of the pixel unit, and a color of any sub-pixel of the pixel unit is same as the color of other adjacent sub-pixels of the adjacent pixel units.

In some embodiments, it can be seen that the pixel unit in the brightness restoration method of the display panel provided in the fifth embodiment of the present disclosure is divided into squares equal to the number of sub-pixels, each sub-pixel occupies a grid, and the position of the sub-pixel can be set in any grid of the pixel unit according to requirements.

In some embodiments, a method for restoring brightness of a display panel is provided by the present disclosure, wherein the pixel unit comprises a red sub-pixel, a green sub-pixel, and a blue sub-pixel, one of the sub-pixels is provided at one end of the pixel unit, other two sub-pixels are provided at the other end of the pixel unit, and a color of any one sub-pixel of the pixel unit is same as the color of adjacent sub-pixels of other adjacent pixel units.

In some embodiments, it should be noted that, when the number of sub-pixel is four, pixel unit comprises red sub-pixel, green sub-pixel, blue sub-pixel and white sub-pixel, the pixel unit is set to be a square, and dividing the square pixel unit into at least two areas for filling at least two sub-pixels comprises: setting the pixel unit to be a square, and dividing the square pixel unit into 4 grids for filling the fourth, fifth, sixth and seventh sub-pixels. In some embodiments, as shown in FIG. 2, the pixel unit is divided into a four rectangular area of an upper left, an upper right, a lower left and a lower right, four sub-pixels are respectively located in the four rectangular area of the pixel unit, and the color of any sub-pixel of the pixel unit is same as the color of the adjacent sub-pixels in other adjacent pixel units. In some embodiments, it should be noted that the position of sub-pixel in the pixel unit can be set according to requirements; in an example of the present embodiment, when the square pixel unit is divided into 3 grids for filling red sub-pixels, green sub-pixels and blue sub-pixels, the sub-pixels of each color can be set in any one of the 3 grids as required.

It can be seen that the pixel unit in the brightness restoration method of the display panel provided by the embodiment of the present disclosure is divided into squares that equal to the number of sub-pixels, each sub-pixel occupies one grid, and the position of the sub-pixel can be set in any grid in the pixel unit according to the requirements.

In some embodiments, display panel of a method for restoring brightness of a display panel is provided by the present disclosure, in a plurality of the pixel units, a color of any one sub-pixel of the pixel unit is same as the color of adjacent sub-pixels of other adjacent pixel units.

In some embodiments, display panel of a method for restoring brightness of a display panel is provided by the present disclosure, a control circuit between the different pixel units is independent of each other.

In some embodiments, display panel of a method for restoring brightness of a display panel is provided by the present disclosure, a brightness of each pixel unit may be controlled independently.

In some embodiments, display panel of a method for restoring brightness of a display panel is provided by the present disclosure, a brightness of at least one sub-pixel in the plurality of pixel units is less than a setting brightness.

In some embodiments, the manner for detecting the brightness of each sub-pixel in the display panel involved in the above step 302 may further include step 11 and step 12.

At step 11, obtaining a current value of each pixel on the substrate;

At step 12, determining a brightness of each pixel on the substrate based on the current value, wherein the brightness of each pixel on the substrate is proportional to the current value.

In some embodiments, it should be noted that the current value of the pixel is proportional to the brightness of the pixel. When the current value of the pixel is abnormally large and exceeds the current value corresponding to other normal brightness, it indicates that the corresponding pixel has a bright spot defect; when the current value of the pixel is abnormally small and lower than the current value corresponding to other normal brightness or cannot detect the current, it indicates that the corresponding pixel has a dark spot defect. It can be seen that the brightness restoration method of the display panel provided in the embodiment of the present disclosure can determine whether the pixel has abnormal brightness according to the current value of the pixel.

In some embodiments, a brightness of the display panel is restored based on at least one second target sub-pixel that is adjacent to the first target sub-pixel and has the same color as the first target sub-pixel pixels, if a first target sub-pixel with abnormal brightness in the display panel involved in step 304 of the present disclosure is detected, as shown in FIG. 4, comprising step 402 and step 404.

At step 402, raising a brightness of the second target sub-pixel in the at least one second pixel unit that is adjacent to the first pixel unit pixels to compensate the brightness of the display panel, if the first target sub-pixel in the first pixel unit in the display panel is a dark spot; and

At step 404, adjusting the first target sub-pixel to be a dark spot, and raising the brightness of the second target sub-pixel in the at least one second pixel unit that is adjacent to the first pixel unit to compensate the brightness of the display panel, the first target sub-pixel in the first pixel unit in the display panel is a bright spot.

In some embodiments, it should be noted that, in an exemplary example of the embodiment, a brightness of the red sub-pixel in the at least one second pixel unit that is adjacent to the first pixel unit pixels is raised to compensate the brightness of the display panel if detecting that the first target sub-pixel in the first pixel unit is a dark spot.

In some embodiments, it should be noted that the method of adjusting the bright spot to the dark spot comprises cutting off the anode of the sub-pixel by laser.

It can be seen that the brightness restoration method for a display panel provided by an embodiment of the present disclosure can solve the technical problem of damage to the display area around the defect point existing in the brightness restoration method of the display panel in the existing art.

In some embodiments, raising a brightness of the second target sub-pixel in the at least one second pixel unit that is adjacent to the first pixel unit pixels to compensate the brightness of the display panel in the steps 402 and 404 of the present disclosure comprises:

adjusting a brightness of the K second target sub-pixels to be M/K times the original brightness respectively when the number of the first target sub-pixels is L; wherein, the L and the K are positive integer, and the M is the sum of the L and the K.

In some embodiments, it should be noted that, in the first example of the embodiment, in conjunction with FIG. 1 and FIG. 2, the first target pixel is a sub-pixel with a dark spot or a sub-pixel adjusted to a dark spot after a bright spot appears. When the number L of the first target sub-pixels is 1, the number of sub-pixels of the same color adjacent to the first target sub-pixel is 3, that is, the value of K is 3, and the brightness of the 3 second target sub-pixels is respectively adjusted to be 4/3 times of the original brightness. In the second example of the embodiment, when the number L of the first target sub-pixels is 2, the number of sub-pixels of the same color adjacent to the first target sub-pixel is 2, that is, the number of K The value is 2, and the brightness of the two second target sub-pixels is respectively adjusted to be twice the original brightness. In the third exemplary example of the embodiment, when the number L of the first target sub-pixels is 3, the number of sub-pixels of the same color adjacent to the first target sub-pixel is 1, that is, the number of K The value is 1, and the brightness of the second target sub-pixel is adjusted to 4 times the original brightness.

It can be seen that the brightness restoration method of the display panel provided by the embodiment of the present disclosure can adjust the brightness of the second target sub-pixels respectively based on the number of the first target sub-pixels, restoring the brightness of the display panel to the level where the first target sub-pixel has no abnormal brightness.

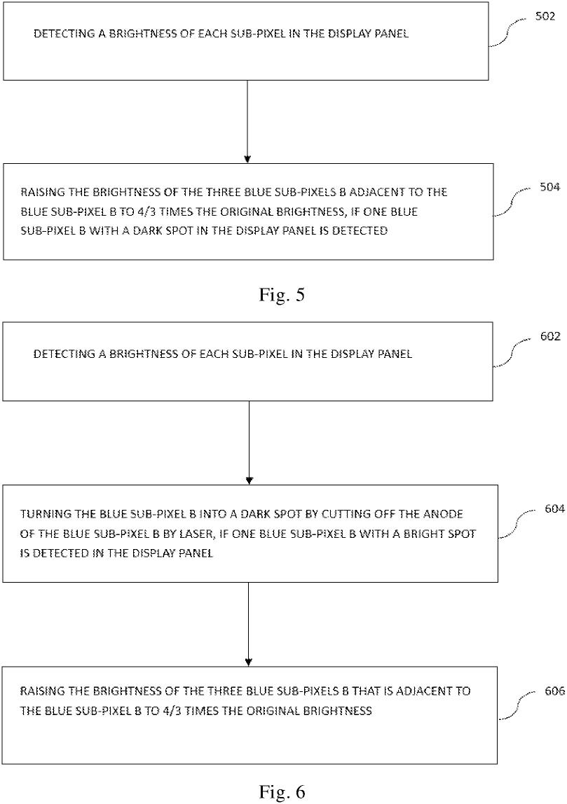

In some embodiments, the display panel comprises a plurality of square pixel units, each pixel unit comprises a red sub-pixel R, a green sub-pixel G, and a blue sub-pixel B, each sub-pixel is adjacent to three sub-pixels of the same color, a partial schematic diagram of the display panel is shown in FIG. 1, and a flowchart of the method is shown in FIG. 5, comprising step 502 and step 504.
At step 502, detecting a brightness of each sub-pixel in the display panel;
At step 504, raising the brightness of the three blue sub-pixels B adjacent to the blue sub-pixel B to 4/3 times the original brightness, if one blue sub-pixel B with a dark spot in the display panel is detected.

In some embodiments, the display panel comprises a plurality of square pixel units, each pixel unit comprises a red sub-pixel R, a green sub-pixel G, and a blue sub-pixel B, each sub-pixel is adjacent to three sub-pixels of the same color, as shown in FIG. 6, the method comprises step 602, step 604 and step 606.
At step 602, detecting a brightness of each sub-pixel in the display panel;
At step 604, turning the blue sub-pixel B into a dark spot by cutting off the anode of the blue sub-pixel B by laser, if one blue sub-pixel B with a bright spot is detected in the display panel;
At step 606, raising the brightness of the three blue sub-pixels B that is adjacent to the blue sub-pixel B to 4/3 times the original brightness.

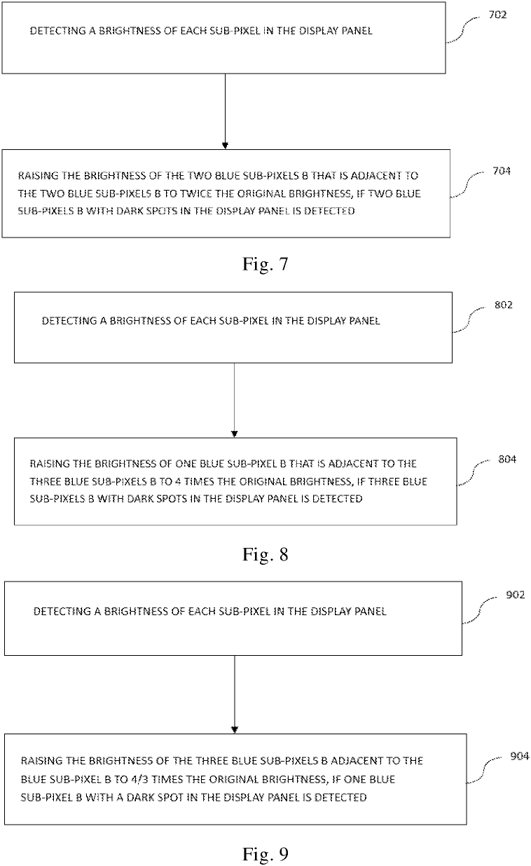

In some embodiments, the display panel comprises a plurality of square pixel units, each pixel unit comprises a red sub-pixel R, a green sub-pixel G, and a blue sub-pixel B, each sub-pixel is adjacent to three sub-pixels of the same color, as shown in FIG. 7, the method comprises step 702 and step 704.
At step 702, detecting a brightness of each sub-pixel in the display panel;
At step 704, raising the brightness of the two blue sub-pixels B that is adjacent to the two blue sub-pixels B to twice the original brightness, if two blue sub-pixels B with dark spots in the display panel is detected.

In some embodiments, a brightness restoration method of the display panel provided by the embodiment of the present disclosure, the display panel comprises a plurality of square pixel units, each pixel unit comprises a red sub-pixel R, a green sub-pixel G, and a blue sub-pixel B, each sub-pixel is adjacent to 3 sub-pixels of the same color, as shown in FIG. 8, the method comprises step 802 and step 804.
At step 802, detecting a brightness of each sub-pixel in the display panel;
At step 804, raising the brightness of one blue sub-pixel B that is adjacent to the three blue sub-pixels B to 4 times the original brightness, if the three blue sub-pixels B with dark spots in the display panel are detected.

In some embodiments, when adjusting the brightness of the second target sub-pixel in at least one second pixel unit adjacent to the first pixel unit, it can also make the brightness value of the second target sub-pixel in at least one second pixel unit adjacent to the first pixel unit greater than the original value, not according to the multiple adjustment. For example, normal brightness value of the second target sub-pixel is L1 (and the original brightness value), and the adjusted brightness value of the second target sub-pixel can be L2, as long as L2 is greater than L1. In other words, compensation in the scheme, as long as the brightness value of the second target sub-pixel increases, the compensation effect has been achieved.

In some embodiments, a brightness restoration method of the display panel provided by the embodiment of the present disclosure, the display panel comprises a plurality of square pixel units, each pixel unit comprises a red sub-pixel R, a green sub-pixel G, a blue sub-pixel B and a white sub-pixel W, each sub-pixel is adjacent to three sub-pixels of the same color, the partial schematic diagram of the display panel is shown in FIG. 2, and the flowchart of the method is shown in FIG. 9, comprising step 902 and step 904.
At step 902, detecting a brightness of each sub-pixel in the display panel;
At step 904, raising the brightness of the three blue sub-pixels B adjacent to the blue sub-pixel B to 4/3 times the original brightness, if one blue sub-pixel B with a dark spot in the display panel is detected.

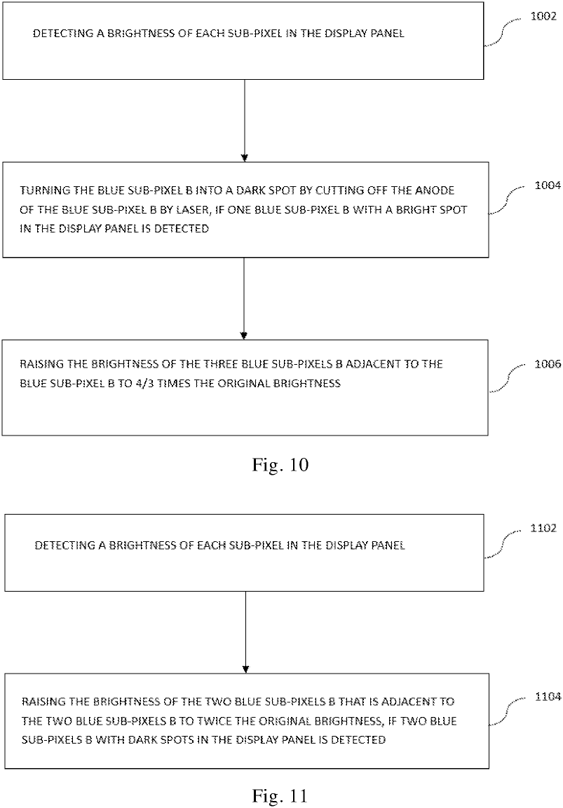

In some embodiments, a brightness restoration method of the display panel provided by the embodiment of the present disclosure, the display panel comprises a plurality of square pixel units, each pixel unit comprises a red sub-pixel R, a green sub-pixel G, and a blue sub-pixel B and a white sub-pixel W, each sub-pixel is adjacent to three sub-pixels of the same color, as shown in FIG. 10, the method comprises step 1002, step 1004 and step 1006.
At step 1002, detecting a brightness of each sub-pixel in the display panel;
At step 1004, turning the blue sub-pixel B into a dark spot by cutting off the anode of the blue sub-pixel B by laser, if one blue sub-pixel B with a bright spot in the display panel is detected; and
At step 1006, raising the brightness of the three blue sub-pixels B adjacent to the blue sub-pixel B to 4/3 times the original brightness.

In some embodiments, a brightness restoration method of the display panel provided by the embodiment of the present disclosure, the display panel comprises a plurality of square pixel units, each pixel unit comprises a red sub-pixel R, a green sub-pixel G, and a blue sub-pixel B and a white sub-pixel W, each sub-pixel is adjacent to three sub-pixels of the same color, as shown in FIG. 11, the method comprises step 1102 and step 1104.
At step 1102, detecting a brightness of each sub-pixel in the display panel;
At step 1104, raising the brightness of the two blue sub-pixels B that is adjacent to the two blue sub-pixels B to twice the original brightness, if two blue sub-pixels B with dark spots in the display panel are detected.

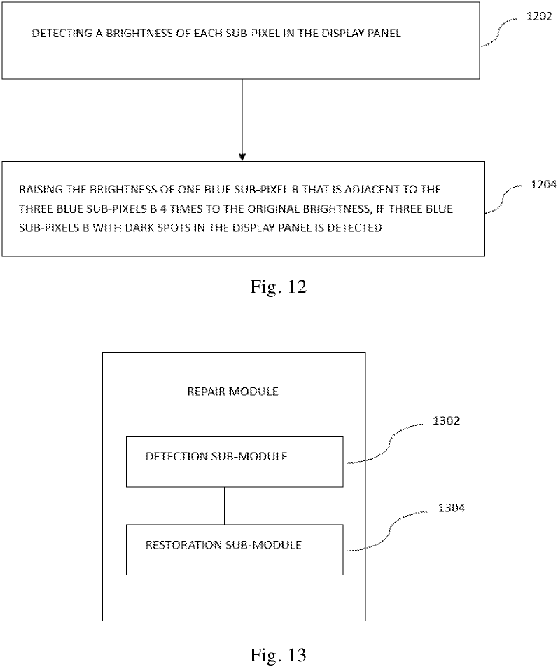

In some embodiments, a brightness restoration method of the display panel provided by the embodiment of the present disclosure, the display panel comprises a plurality of square pixel units, each pixel unit comprises a red sub-pixel R, a green sub-pixel G, and a blue sub-pixel B and a white sub-pixel W, each sub-pixel is adjacent to three sub-pixels of the same color, as shown in FIG. 12, the method comprises step 1202 and step 1204.
At step 1202, detecting a brightness of each sub-pixel in the display panel;
At step 1204, raising the brightness of one blue sub-pixel B that is adjacent to the three blue sub-pixels B 4 times to the original brightness, if three blue sub-pixels B with dark spots in the display panel are detected.

It can be seen that the brightness restoration method of the display panel provided by the embodiment of the present disclosure can perform the brightness restoration of the display panel according to the first target sub-pixel and the adjacent second target sub-pixel of the same color with the dark spot defect or the bright spot defect, so as to solve the technical problem of damaging to the display area around the defect point existing in the brightness restoration method of the display panel in the existing art.
An embodiment of the present disclosure provides a display module, comprising the above-mentioned display panel and a repair module connected with the display panel; the display panel comprises a substrate, and a plurality of pixel units provided on the substrate, wherein each of the pixel units comprises a plurality of sub-pixels arranged in a preset arrangement manner, and the preset arrangement manner is that each sub-pixel of each color is adjacent to at least one of the sub-pixels of the same color, as shown in FIG. 13, the repair module comprises:
   a detection sub-module 1302 configured to detect a brightness of each sub-pixel in the display panel; the display panel comprises a plurality of sub-pixels arranged in a preset arrangement manner, the plurality of sub-pixels comprises sub-pixels of different color, the preset arrangement manner is that the sub-pixels of each color is adjacent to at least one of the sub-pixels of the same color;
   a restoration sub-module 1304 configured to restore a brightness of the display panel, based on at least one second target sub-pixel that is adjacent to a first target sub-pixel and has an identical color to that of the first target sub-pixel pixels in the case of detecting that there is a first target sub-pixel with abnormal brightness in the display panel.

In some embodiments, it should be noted that the manner of detecting sub-pixels with abnormal brightness comprises detecting sub-pixels with dark spot defects and sub-pixels with bright spot defects. The detection method may be detecting whether there is a dark spot defect on the display panel through an external device and determine the position of the sub-pixel with the dark spot defect; For example, a precise pattern detector (CCD) is used to analyze the brightness information of each position of the screen, so as to determine the position of the sub-pixels with dark spot defects, and a detector may also be formed in the display panel to detect the current that flows through the pixels. In a certain range, the brightness is proportional to the current, and the position of the sub-pixel with the dark spot defect is determined according to the current.

Through the display module provided by the embodiment of the present disclosure, the brightness of each sub-pixel in the display panel is detected by the detection sub-module; wherein, the display panel comprises a plurality of sub-pixels arranged in a preset arrangement manner, the plurality of sub-pixels include a plurality of sub-pixels of different colors, the preset arrangement manner is that the sub-pixels of each color is adjacent to at least one of the sub-pixels of the same color; a brightness of the display panel based on at least one second target sub-pixel that is adjacent to the first target sub-pixel and has an identical color to that of the first target sub-pixel pixels is restored, if a first target sub-pixel with abnormal brightness in the display panel is detected by the restoration sub-module; That is, a brightness of the display panel is restored according to at least one second target sub-pixel that is adjacent to the first target sub-pixel and has an identical color to that of the first target sub-pixel pixels, thereby solving the problem that the brightness restoration method of the display panel in the prior art will damage the display area around the defect point.

In some embodiments, a display module is provided by the present disclosure, the pixel unit comprises N sub-pixels and is divided into N rectangular areas, and the N rectangular areas of the pixel unit is filled by the N sub-pixels respectively; N is a positive integer greater than 2.

In some embodiments, a display module is provided by the present disclosure, the pixel unit comprises a red sub-pixel, a green sub-pixel, and a blue sub-pixel, one of the sub-pixels is provided at one end of the pixel unit, other two sub-pixels are provided at the other end of the pixel unit, and a color of any one sub-pixel of the pixel unit is same as the color of adjacent sub-pixels of other adjacent pixel units.

In some embodiments, a display module is provided by the present disclosure, the pixel unit comprises a red sub-pixel, a green sub-pixel, a blue sub-pixel, and a white sub-pixel, each sub-pixel is adjacent to at least one sub-pixel of the same color, the pixel unit is divided into a four rectangular area of an upper left, an upper right, a lower left and a lower right, four sub-pixels are respectively located in the four rectangular area of the pixel unit, and the color of any sub-pixel of the pixel unit is same as the color of the adjacent sub-pixels in other adjacent pixel unit.

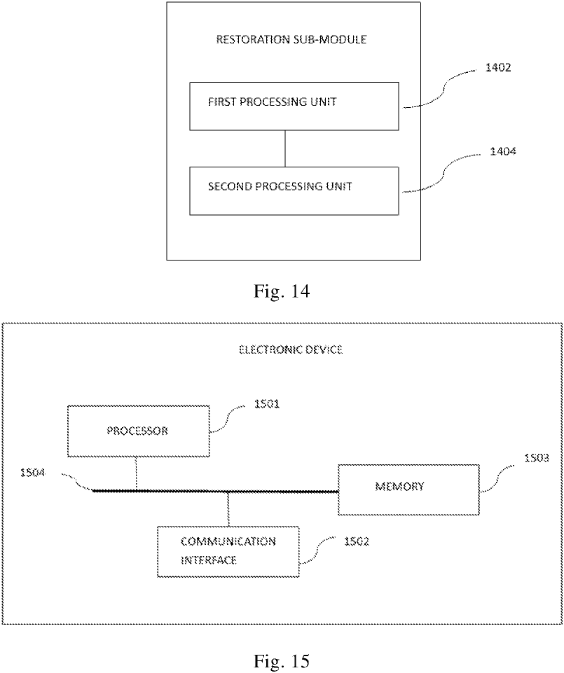

In some embodiments, the restoration sub-module 1304 provided by the embodiment of the present disclosure, as shown in FIG. 14, may further comprise:
A first processing unit 1402 configured to increase the brightness of the second target sub-pixel in at least one second pixel unit adjacent to the first pixel unit to compensate the brightness of the display panel, if the first target sub-pixel with a dark spot in the first pixel unit in the display panel is detected;
A second processing unit 1404, configured to adjust the first target sub-pixel to be a dark point and increasing the brightness of the second target sub-pixel in at least one second pixel unit that is adjacent to the first pixel unit to compensate the brightness of the display panel, if the first target sub-pixel with a bright spot in the first pixel unit in the display panel is detected.

In some embodiments, the first processing unit 1402 and the second processing unit 1404 provided by the embodiment of the present disclosure may further comprise:
An adjustment sub-unit, configured to adjust a brightness of the K second target sub-pixels to be M/K times the original brightness respectively when the number of the first target sub-pixels is L; wherein, the L and the K are positive integer, and the M is the sum of the L and the K.
An embodiment of the present disclosure further provides an electronic device, as shown in FIG. 15, comprising a processor 1501, a communication interface 1502, a memory 1503 and a communication bus 1504, wherein the processor 1501, the communication interface 1502, and the memory 1503 communicate with each other via the communication bus 1504,

The memory 1503 is configured to store computer programs;
The processor 1501 is configured to implement the method steps in FIG. 1 when executing the program stored in the memory 1503, and the functions of the processor 1501 are the same as the method steps in FIG. 1, which will not be repeated here.

The communication bus mentioned by the above terminal may be a Peripheral Component Interconnect (PCI for short) bus or an Extended Industry Standard Architecture (EISA for short) bus or the like. The communication bus may be an address bus, a data bus, a control bus, and the like. For ease of representation, only one thick line is shown in FIG. 15, but it does not mean that there is only one bus or one type of bus.

The communication interface is configured for communication between the above-mentioned terminal and other devices.

The memory may include Random Access Memory (RAM for short), and may also include non-volatile memory, such as at least one disk memory. Optionally, the memory may also be at least one storage device located away from the aforementioned processor.

The above-mentioned processor may be a general-purpose processor, comprising a Central Processing Unit (CPU for short), a Network Processor (NP for short), etc.; may also be a Digital Signal Processing (DSP for short), Disclosure Specific Integrated Circuit (ASIC for short), Field-Programmable Gate Array (FPGA for short) or other programmable logic devices, discrete gate or transistor logic devices, and discrete hardware components.

In some embodiments, a computer-readable storage medium storing instructions is also provided, when executing on a computer, the instructions make the computer to execute the method for restoring brightness of a display panel described in any of the foregoing embodiments.

In some embodiments, a computer program product comprising instructions is also provided, when executing on a computer, the instructions make the computer to execute the method for restoring brightness of a display panel described in any of the foregoing embodiments.

The above-mentioned embodiments may be implemented in whole or in part by software, hardware, firmware or any combination thereof. When implementing by software, it can be implemented in whole or in part in the form of a computer program product. The computer program product comprises one or more computer instructions. When the computer program instructions are loading and executing on a computer, the whole or part of the processes or functions described in the embodiments of the present disclosure are generated. The computer may be a general-purpose computer, special-purpose computer, computer network, or other programmable device. The computer instructions may be stored in computer-readable storage medium or transmitted from one computer-readable storage medium to another computer-readable storage medium, for example, the computer instructions may be transmitted from one website site, computer, server, or data center to another website site computer, server or data center by wire (eg, coaxial cable, fiber optic, digital subscriber line (DSL)) or wireless (eg, infrared, wireless, microwave, etc.). The computer-readable storage medium may be any available medium that can be accessed by a computer or a server, data center and the other storage device integrated by one or more available media. The available media may be magnetic media (eg, floppy disks, hard disks, magnetic tapes), optical media (eg, DVD), or semiconductor media (eg, Solid State Disk (SSD)), or the like.

It should be noted that, in this document, relational terms such as first and second and the others are only used to distinguish one entity or operation from another and do not necessarily require or imply any such actual relationship between these entities or operations or sequence. Moreover, the terms “comprising”, “comprising” or any other variation thereof are intended to encompass a non-exclusive inclusion such that a process, method, article or device that comprises a list of elements comprises not only those elements, but also comprises not explicitly listed or other elements inherent to such a process, method, article or apparatus. Without further limitation, an element qualified by the phrase “comprising a...” does not preclude the presence of additional identical elements in a process, method, article or apparatus that comprises the element.

Each embodiment in this specification is described in a related manner, and the same and similar parts between the various embodiments may be referred to each other, and each embodiment focuses on the differences from other embodiments. In particular, as for the system embodiments, since they are basically similar to the method embodiments, the description is relatively simple, and for related parts, please refer to the partial descriptions of the method embodiments.

The above descriptions are only preferred embodiments of the present disclosure, and are not intended to limit the protection scope of the present disclosure. Any modification, equivalent replacement, improvement, etc. made within the spirit and principle of the present disclosure are included in the protection scope of the present disclosure.

What is claimed is:

1. A display panel, comprising:
a substrate, and
a plurality of pixel units provided on the substrate,
wherein each of the pixel units comprises a plurality of sub-pixels arranged in a preset arrangement manner, and the preset arrangement manner is that each sub-pixel of each color is adjacent to at least one of the sub-pixels of the same color.

2. The display panel of claim 1, wherein the pixel unit comprises N sub-pixels and is divided into N rectangular areas, and the N rectangular areas of the pixel unit is filled by the N sub-pixels respectively; N is a positive integer greater than 2.

3. The display panel of claim 2, wherein the pixel unit comprises a red sub-pixel, a green sub-pixel, and a blue sub-pixel, one of the sub-pixels is provided at one end of the pixel unit, other two sub-pixels are provided at the other end of the pixel unit, and a color of any one sub-pixel of the pixel unit is same as the color of adjacent sub-pixels of other adjacent pixel units.

4. The display panel of claim 3, wherein the pixel unit comprises a red sub-pixel, a green sub-pixel, a blue sub-pixel, and a white sub-pixel, each sub-pixel is adjacent to at least one sub-pixel of the same color, the pixel unit is divided into a four rectangular area of an upper left, an upper right, a lower left and a lower right, four sub-pixels are respectively located in the four rectangular area of the pixel unit, and the color of any sub-pixel of the pixel unit is same as the color of the adjacent sub-pixels in other adjacent pixel unit.

5. The display panel of claim 1, in a plurality of the pixel units, a color of any one sub-pixel of the pixel unit is same as the color of adjacent sub-pixels of other adjacent pixel units.

6. The display panel of claim 1, a control circuit between the different pixel units is independent of each other.

7. The display panel of claim 6, a brightness of each pixel unit may be controlled independently.

8. The display panel of claim 1, a brightness of at least one sub-pixel in the plurality of pixel units is less than a setting brightness.

9. A method for restoring brightness of a display panel, wherein the display panel comprises a substrate, and a plurality of pixel units provided on the substrate, wherein each of the pixel units comprises a plurality of sub-pixels arranged in a preset arrangement manner, and the preset arrangement manner is that each sub-pixel of each color is adjacent to at least one of the sub-pixels of the same color, wherein the method comprises:
detecting a brightness of each sub-pixel in the display panel;
restoring a brightness of the display panel based on at least one second target sub-pixel that is adjacent to the first target sub-pixel and has an identical color to that of the first target sub-pixel pixels, if a first target sub-pixel with abnormal brightness in the display panel is detected.

10. The method of claim 9, wherein the pixel unit comprises N sub-pixels, areas corresponding to pixel units are divided into N rectangular areas, and the N rectangular areas of the pixel unit is filled by the N sub-pixels respectively, and a rectangular area is filled with a sub-pixel; N is a positive integer greater than 2.

11. The method of claim 9, wherein the pixel unit comprises a red sub-pixel, a green sub-pixel, and a blue sub-pixel, one of the sub-pixels is provided at one end of the pixel unit, other two sub-pixels are provided at the other end of the pixel unit, and a color of any one sub-pixel of the pixel unit is same as the color of adjacent sub-pixels of other adjacent pixel units.

12. The method of claim 9, wherein the pixel unit comprises a red sub-pixel, a green sub-pixel, and a blue sub-pixel, one of the sub-pixels is provided at one end of the pixel unit, other two sub-pixels are provided at the other end of the pixel unit, and a color of any one sub-pixel of the pixel unit is same as the color of adjacent sub-pixels of other adjacent pixel units.

13. The method of claim 9, wherein detecting a brightness of each sub-pixel in the display panel comprises:
obtaining a current value of each pixel on the substrate; and
determining a brightness of each pixel on the substrate based on the current value, wherein the brightness of each pixel on the substrate is proportional to the current value.

14. The method of claim 9, wherein restoring the brightness of the display panel based on at least one second target sub-pixel that is adjacent to the first target sub-pixel and has an identical color to that of the first target sub-pixel pixels, if a first target sub-pixel with abnormal brightness in the display panel is detected, comprising:
raising a brightness of a second target sub-pixel in at least one second pixel unit that is adjacent to the first pixel unit pixels to compensate the brightness of the display panel, if the first target sub-pixel in the first pixel unit in the display panel is a dark spot; and
adjusting the first target sub-pixel to be a dark spot and raising the brightness of the second target sub-pixel in at least one second pixel unit that is adjacent to the first pixel unit to compensate the brightness of the display panel, if the first target sub-pixel in the first pixel unit in the display panel is a bright spot.

15. The method of claim 14, wherein raising the brightness of the second target sub-pixel in the at least one second pixel unit that is adjacent to the first pixel unit pixels to compensate the brightness of the display panel comprises:
adjusting a brightness of the K second target sub-pixels to be M/K times the original brightness respectively if the number of the first target sub-pixels is L; wherein, the L and the K are positive integer, and the M is the sum of the L and the K.

16. A display module, comprising a display panel and a repair module connected with the display panel, the display panel comprising a substrate, and a plurality of pixel units provided on the substrate, wherein each of the pixel units comprises a plurality of sub-pixels arranged in a preset arrangement manner, and the preset arrangement manner is that each sub-pixel of each color is adjacent to at least one of the sub-pixels of the same color, wherein the repair module comprises:
a detection sub-module, configured to detect a brightness of each sub-pixel in the display panel; and
a restoration sub-module, configured to restore a brightness of the display panel based on at least one second target sub-pixel that is adjacent to the first target sub-pixel and has an identical color to that of the first target sub-pixel pixels if a first target sub-pixel with abnormal brightness in the display panel is detected.

17. The display module of claim 16, wherein the pixel unit comprises N sub-pixels and is divided into N rectangular areas, and the N rectangular areas of the pixel unit is filled by the N sub-pixels respectively, N is a positive integer greater than 2.

18. The display module of claim 16, wherein the pixel unit comprises a red sub-pixel, a green sub-pixel, and a blue sub-pixel, one of the sub-pixels is provided at one end of the pixel unit, other two sub-pixels are provided at the other end of the pixel unit, and a color of any one sub-pixel of the pixel unit is same as the color of adjacent sub-pixels of other adjacent pixel units.

19. The display module of claim 16, wherein the pixel unit comprises a red sub-pixel, a green sub-pixel, and a blue sub-pixel, one of the sub-pixels is provided at one end of the pixel unit, other two sub-pixels are provided at the other end of the pixel unit, and a color of any one sub-pixel of the pixel unit is same as the color of adjacent sub-pixels of other adjacent pixel units.
